(19) United States
(12) Patent Application Publication
(10) Pub. No.: US 2018/0196750 A1
(43) Pub. Date: Jul. 12, 2018

(54) AGGREGATING MESSAGES FOR REDUCING CACHE INVALIDATION RATE

(71) Applicant: Apple Inc., Cupertino, CA (US)

(72) Inventors: Ben Shilo, Tel Aviv (IL); Arie Peled, Tel Mond (IL); Tal Ostro, Ganey Tikva (IL)

(21) Appl. No.: 15/401,041

(22) Filed: Jan. 8, 2017

(51) Int. Cl. G06F 12/0808; H04L 29/08; G06F 3/06; G06F 12/128

(52) U.S. Cl. CPC G06F 12/0808; H04L 67/2842; G06F 3/0679; G06F 2212/69; G06F 3/0659; G06F 12/128; G06F 3/0607

(57) ABSTRACT

A storage device includes a nonvolatile memory and a controller. The controller is configured to store in the nonvolatile memory data for a host, to generate messages having a message size to be cached in the host in a cache memory having a cache-line size larger than the message size, to aggregate two or more of the messages by producing an aggregated message that matches the cache-line size, and to send the aggregated message to the host.

### TECHNICAL FIELD

Embodiments described herein relate generally to storage systems, and particularly to methods and systems for aggregating messages for reducing the rate of cache invalidation.

### BACKGROUND

In various storage systems a host stores data in a storage device such as a Solid State Drive (SSD). For fast access, the host may store frequently used data in a local cache memory. Methods for cache management such as reducing the amount of cache trashing are known in the art. For example, U.S. Patent Application Publication 2006/0179225, whose disclosure is incorporated herein by reference, describes instruction cache trashing caused by Interrupt Service Routines (ISR). To reduce trashing of the instruction cache memory, the instruction cache is dynamically partitioned into a first memory portion and a second memory portion during execution. The first memory portion is for storing instructions of the current instruction stream, and the second memory portion is for storing instructions of the ISR. Thus, the ISR only affects the second memory portion and leaves instruction data stored within the first memory portion intact.

U.S. Patent Application Publication 2008/0235484, whose disclosure is incorporated herein by reference, describes aspects of a method and system for host memory alignment that may include splitting a received read and/or write I/O request at a first of a plurality of memory cache line boundaries to generate a first portion of the received I/O request. A second portion of the received read and/or write I/O request may be split into a plurality of segments that are each aligned with one or more of the plurality of memory cache line boundaries.

### SUMMARY

An embodiment that is described herein provides a storage device that includes a nonvolatile memory and a controller. The controller is configured to store in the nonvolatile memory data for a host, to generate messages having a message size to be cached in the host in a cache memory having a cache-line size larger than the message size, to aggregate two or more of the messages by producing an aggregated message that matches the cache-line size, and to send the aggregated message to the host.

In some embodiments, the controller is configured to aggregate the two or more of the messages so that the aggregated message will be stored in the cache memory in a single cache entry. In other embodiments, the controller is configured to aggregate the two or more of the messages in accordance with an alignment that the host maintains between cache entries of the cache memory and messages queued in the host. In yet other embodiments, the cache-line size is an integer multiple of the message size, and the controller is configured to aggregate a number of messages up to the integer multiple.

In an embodiment, the controller is configured to receive from the host, over a communication link, multiple commands for execution, and to generate the messages in response to completing execution of the respective commands. In another embodiment, in response to detecting that a number of currently-aggregated messages remains less than required for matching the cache-line size for more than a predefined duration, the controller is configured to send the aggregated message to the host with only the currently-aggregated messages. In yet another embodiment, the controller is configured to produce the aggregated message and send the aggregated message to the host when a number of received commands that are pending execution exceeds a predefined threshold number, and to otherwise send individual messages to the host without aggregation.

There is additionally provided, in accordance with an embodiment that is described herein, a method, including, in a controller that stores data for a host in a nonvolatile memory, generating messages having a message size, the messages are to be cached in the host in a cache memory having a cache-line size larger than the message size. Two or more of the messages are aggregated by producing an aggregated message that matches the cache-line size. The aggregated message is sent to the host.

There is additionally provided, in accordance with an embodiment that is described herein, a storage system that includes a host, a storage device and aggregation logic. The storage device is configured to store data for the host in a nonvolatile memory, and to generate messages having a message size to be cached in the host in a cache memory having a cache-line size larger than the message size. The aggregation logic is configured to aggregate two or more of the messages generated by the storage device by producing an aggregated message that matches the cache-line size, and to send the aggregated message to the host.

These and other embodiments will be more fully understood from the following detailed description of the embodiments thereof, taken together with the drawings in which:

### BRIEF DESCRIPTION OF THE DRAWINGS

FIG. 1 is a block diagram that schematically illustrates a storage system implementing an efficient cache invalidation scheme, in accordance with an embodiment that is described herein;

FIG. 2 is a flow chart that schematically illustrates a method for reducing cache invalidation rate, in accordance with an embodiment that is described herein; and

FIG. 3 is a message diagram that schematically illustrates a process of handling aggregated completion notifications in a storage system, in accordance with an embodiment that is described herein.

### DETAILED DESCRIPTION OF EMBODIMENTS

### Overview

Various storage systems comprise a host that stores data in a storage device such as a Solid State Drive (SSD). The host and storage device typically communicate with one another using a suitable protocol such as the NVM Express (NVMe) protocol.

Embodiments that are described herein provide improved methods and systems for managing the communication of messages between the memory device and the host for improving host performance.

In the disclosed embodiments, to carry out a storage operation, e.g., writing or reading, the host sends to the storage device a suitable command. The storage device executes the command, and upon completion returns to the host a respective notification message, also referred to as a “completion notification.” The size of the notification messages is referred to herein as a “message size.” For example, the NVMe protocol specifies completion notification messages having a default message size of 16 Bytes.

The host typically comprises a CPU, a local memory (e.g., a DRAM) and a cache memory. At the host, the notification messages are written to the DRAM, which causes invalidation of an associated cache line of the cache memory, and upon request, e.g., by the CPU applying a reading operation, transferred to the cache memory to be served by the CPU. Transferring data from the DRAM into the cache is carried out in blocks that are referred to as “cache lines” or “cache entries” having a fixed size referred to as a “cache-line size.”

In the disclosed embodiments, the cache-line size is larger than the message size of the notification messages (e.g., 64 Bytes and 16 Bytes, respectively). The host maintains an alignment between the cache entries and respective groups of multiple (e.g., four) consecutive queued notifications, so that an entire cache entry can be updated from the queue in a single fetching transaction.

In principle, the storage device could send to the host each notification message separately, e.g., immediately upon completing command execution. This, however, may cause redundant re-fetching of the same cache entry from the DRAM because writing partial cache-lines to the DRAM invalidates the existing copy in the cache, even though the cache entry contains one or more notification messages ready to be served by the CPU, as will be explained herein.

To serve a cached notification message, the CPU typically needs to access the relevant cache entry multiple times. In case the notification messages are sent by the storage device separately, one or more notification messages may arrive at the host while the CPU is still serving a previously cached notification message. As a result, although the notification being served is already available in the cache, each subsequent notification message arriving may undesirably invalidate the cache entry and cause redundant re-fetching from the DRAM. The CPU has to wait for the re-fetching to complete before resuming serving the notification message, and the additional latencies incurred degrade the CPU performance.

In the disclosed embodiments, instead of sending the notification messages one at a time, the storage device aggregates two or more notification messages to produce an aggregated message that matches the cache-line size of the host, and sends the aggregated message to the host. In an example embodiment, the storage device aggregates groups of four 16-Byte notification messages to match a 64-Byte cache-line size, and sends the 64-Byte aggregated messages to the host.

In an embodiment, the storage device is aware of the alignment that the host maintains between the cache entries and the queued notification messages. The storage device synchronizes the aggregation of messages so that (i) each aggregated message will cause only a single cache invalidation event in the host, and (ii) the respective notification messages will be fetched to the relevant cache entry in only a single fetching transaction. This scheme enables the CPU to serve each of the notification messages of the cache entry with no redundant cache line fetches.

In some situations, the storage device has fewer notification messages than required to produce a full aggregated message for sending to the host, e.g., because the host has no further commands to send to the storage device. As a result, the storage device may fail to send (or undesirably delay the sending of) one or more pending notification messages. In some embodiments, to break such a deadlock situation, the storage device sends to the host any pending notification messages it has, when unable to complete aggregating the notification messages to match the cache-line size for more than a predefined period of time.

Using the disclosed aggregation techniques reduces the rate of cache invalidation events significantly, compared to reporting each notification message separately. The level of improvement depends on various factors such as the ratio between the cache-line size and message size, the CPU activity pattern, and the distribution of the commands sent by the host over time. Moreover, by using the disclosed techniques, the host CPU can serve multiple notification messages available in a cache entry without unnecessarily re-fetching this cache entry, therefore improving both CPU and cache performance.

### System Description

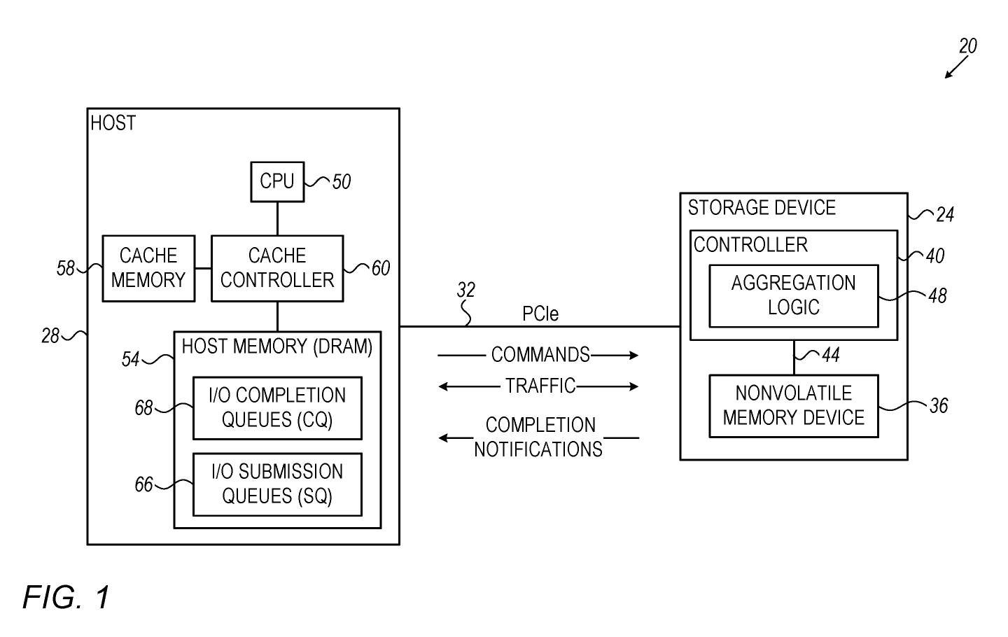

FIG. 1 is a block diagram that schematically illustrates a storage system implementing an efficient cache invalidation scheme, in accordance with an embodiment that is described herein. Storage system 20 comprises a storage device 24 that stores data for a host 28. In the present example, the storage device of system 20 comprises a Solid-State Disk (SSD) that stores data for a host computer. In alternative embodiments, however, system 20 may be used in any other suitable application and with any other suitable host, such as in computing devices, cellular phones or other communication terminals, removable memory modules, Secure Digital (SD) cards, Multi-Media Cards (MMC) and embedded MMC (eMMC), digital cameras, music and other media players and/or any other system or device in which data is stored and retrieved.

Host 28 and storage device 24 communicate with one another over a link 32 in performing storage operations such as writing data to and retrieving data from storage device 24.

In the present example, link 32 comprises a Peripheral Component Interconnect Express (PCIe) bus. Alternatively, link 32 may comprise any other suitable bus or communication link. Host 28 and storage device 24 may communicate over link 32 using any suitable protocol such as, for example, the NVM Express (NVMe) protocol, which is specified, for example, by the NVM Express organization, in “NVM Express,” revision 1.2.1, Jun. 5, 2016, which is incorporated herein by reference. Alternatively, the Serial AT Attachment (SATA) protocol or other suitable protocols can also be used.

Storage device 24 comprises a nonvolatile memory device 36 in which the storage device stores data. Memory device 36 may employ any suitable memory technology, such as, for example, storing the data in an array of multiple solid-state memory cells of any kind, such as NAND Flash or other suitable memory cells.

The storage and retrieval of data in and out of memory device 36 is performed by a memory controller 40, which communicates with memory device 36 using an internal suitable link 44. Memory controller 40 communicates with host 28, for accepting data for storage in the memory device and for outputting data retrieved from the memory device. In some embodiments, memory device 36 is implemented as multiple separate memory devices that commonly connect to memory controller 40 via link 44.

In the embodiments disclosed below, host 28 communicates with storage device 24 in a master-slave manner. As such, the host issues commands for execution by storage device 24, and upon execution completion, the storage device returns to the host respective completion notification messages (also referred to simply as “completion notifications,” for brevity). The commands issued by the host may comprise storage commands for writing or reading data, or control commands.

Host 28 comprises a Central Processing Unit (CPU) 50 that carries out the various tasks of the host. Host 28 comprises a local host memory 54, and a cache memory 58 that are each accessible by the CPU. In some embodiments, host 28 further comprises a cache controller 60 that manages the operation of cache memory 58 and interconnects between the CPU and local host memory 54. The cache controller is typically implemented in hardware for fast access. Cache controller 60 maintains cache coherency of cache memory 58 by invalidating a relevant cache line in response to updating the DRAM content, and fetching the updated data from the DRAM into the invalidated cache line. The CPU accesses the DRAM via the cache controller, as will be described below.

The host architecture depicted in FIG. 1 is not mandatory for the disclosed embodiments, and other suitable architectures can also be used. For example, although in FIG. 1 the cache controller resides in the host externally to the CPU, in alternative embodiments, the cache controller can be implemented in hardware within the CPU die.

Host memory 54 may comprise any type of memory such as, for example, a Dynamic Random Access Memory (DRAM). Typically DRAM 54 has a larger storage capacity than cache memory 58, but DRAM 54 incurs longer accessing latencies by the CPU compared to cache memory 58. Therefore, data that the CPU accesses frequently is typically transferred or copied from the DRAM to the cache memory.

For example, the DRAM may have a capacity between 0.5 and 64 GBytes with access time on the order of hundreds of nanoseconds, and the cache memory may have a capacity between 4 and 512 KBytes with access time on the order of tens of nanoseconds. Alternatively, other storage capacities and access latencies can also be used.

Although in FIG. 1, CPU 50 and cache memory 58 are depicted as separate elements of the host, in alternative embodiments, cache memory 58 is integrated within the CPU die and connected to the CPU via a suitable internal bus.

To read data from the DRAM, the CPU issues a read request to the cache controller, which attempts reading the data from the cache memory, first. When unavailable or un-updated in the cache, the cache controller fetches the data from DRAM 54 and stores the fetched data in cache memory 58 to be available for subsequent CPU requests. In an embodiment, when the data stored in DRAM 54 is overwritten and modified relative to its cached version, the memory controller fetches the updated version of the data from the DRAM into the cache.

In some embodiments, storing data in cache memory 58 is carried out in units referred to as “cache lines” having a cache-line size. For example, cache memory 58 may have a cache-line size of 64 Bytes or any other suitable size. The cache lines of cache memory 58 are also referred to herein as “cache entries.”

Host 28 manages in DRAM 54 one or more Submission Queues (SQs) 66, each comprising multiple SQ elements, and one or more Completion Queues (CQs) 68, each comprising multiple CQ elements. The host submits commands for execution by the storage device in the SQ elements of SQ 66, and accepts completion notifications sent by the storage device and queued in the CQ elements of CQ 68.

In an embodiment, each SQ element stores a single command, and each CQ element stores a single completion notification. In some embodiments, SQ 66 and CQ 68 are implemented as circular buffers. A given SQ is typically associated with only one CQ, but multiple SQs may be mapped to a single CQ. In some embodiments, CPU 50 comprises multiple processing cores (not shown) that each has dedicated one or more SQs and one or more CQs.

An SQ element in SQ 66 may comprise various fields such as, for example, an opcode specifying the command type (e.g., read or write operation), a command identifier within the SQ, a pointer to a memory of the host (e.g., within the DRAM) related to the data transferred and the like. A CQ element may comprise various fields such as, for example, a pointer to an associated SQ, a command identifier within the associated SQ, a status field indicating pass/fail of the command execution and the like.

The SQ elements of SQ 66 and the CQ elements of CQ may be configured to any suitable sizes. In the disclosed embodiments, the size of the CQ elements is smaller than the cache-line size. In the description that follows we assume that each CQ element stores a single completion notification message, and therefore the ratios between the cache-line size and each of the message size or the CQ element size, are the same.

The cache-line size may be an integer multiple of the CQ element size, e.g., 64 Bytes and 16 Bytes, respectively, in which case four CQs can be fetched into a single cache line. The disclosed embodiments are also applicable, however, for cache memories having a cache line-size that is not an integer multiple of the CQ element size.

In some embodiments, the host manages (e.g., using the cache controller) an alignment between the cache lines in the cache and respective groups of multiple consecutive CQ elements in CQ 68. For example, when the cache-line size is four times larger than the size of the completion notifications, the first cache line is aligned with the group of CQ elements CQ(1) . . . CQ(4), the second cache line is aligned with the group of CQ elements CQ(5) . . . CQ(8) and so on. When a given cache line is invalidated, the cache controller fetches the entire respective group of CQ elements from CQ 68 into the invalidated cache line in a single fetching transaction. In this example, a cache line may store up to four completion notifications at any given time.

The CPU may detect unserved completion notifications in the CQ by polling the DRAM via the cache controller. Alternatively, the CPU gets an interrupt signal from the cache controller, indicating the unserved completion notifications.

Storage device 24 comprises aggregation logic 48, which is configured to aggregate two or more completion notifications to produce an aggregated message to be sent to host 28. In the present example, the aggregation logic is implemented as part of the memory controller functionality. In alternative embodiments, however, the functionality of the aggregation logic may be implemented separately from the memory controller. In yet other alternative embodiments, the aggregation functionality is split between controller 40 and aggregation logic 48.

In some embodiments, aggregation logic 48 aggregates multiple completion notifications to match the cache-line size, e.g., aggregate four 16-Byte completion notifications to match a 64-Byte cache-line size.

In the example of FIG. 1, aggregation logic 48 is implemented within storage device 24. In alternative embodiments, at least part of the functionality of aggregation logic 48 can be implemented outside the storage device, e.g., in host 28, as will be described below.

In some embodiments, aggregation logic 48 is aware of the alignment that the host manages between the cache lines of cache memory 58 and the CQ elements of CQ 68, and aggregates the completion notifications in synchronization with this alignment. As a result, cache controller 60 in the host will fetch the completion notifications sent within an aggregated message into the respective cache line in a single fetching transaction.

When the host receives one or more completion notifications in an aggregated message from the memory device, the host stores the completion notifications contained in the message in subsequent available CQ elements of CQ 68 that are aligned with a respective cache line of the cache memory. Note that for each aggregated message received, a single invalidation notification is generated, and by aggregating multiple completion notifications within the aggregated message, the rate of invalidation events reduces.

Although in the system of FIG. 1, aggregation logic is comprised in storage device 24, this is not mandatory. For example, in an alternative embodiment, aggregation logic 48 is comprised in host 28. In this embodiment, the storage device sends to the host individual (i.e., not aggregated) completion notifications, which the host stores in respective CQ elements in the DRAM. When a full group of completion notifications aligned to a given cache line becomes available, the given cache line can be transferred (e.g., upon CPU request to the cache controller) to the cache in a single fetching cycle.

As another example, the functionality of aggregation logic 48 may be implemented externally to both the storage device and the host, e.g., by some component coupled to link 32, by aggregating intercepted completion notifications sent separately by the storage device, and sending to the host aggregated messages.

Memory controller 40, and in particular aggregation logic 48, may be implemented in hardware, e.g., hard-wired hardware or programmable hardware such as a suitable Field-Programmable Gate Array (FPGA) or Application-Specific Integrated Circuit (ASIC). Alternatively, the memory controller may comprise a microprocessor that runs suitable software, or a combination of hardware and software elements. In some embodiments, memory controller 40 comprises a general-purpose processor, which is programmed in software to carry out the functions described herein. The software may be downloaded to the processor in electronic form, over a network, for example, or it may, alternatively or additionally, be provided and/or stored on tangible media, such as magnetic, optical, or electronic memory.

The system configuration of FIG. 1 is an example configuration, which is shown purely for the sake of conceptual clarity. Any other suitable storage system configuration can also be used. Elements that are not necessary for understanding the principles of the present invention, such as various interfaces, addressing circuits, timing and sequencing circuits and debugging circuits, have been omitted from the figure for clarity.

In the exemplary system configuration shown in FIG. 1, memory device(s) 36 and memory controller 40 of the storage device are implemented as separate Integrated Circuits (ICs). In alternative embodiments, however, the memory device(s) and the memory controller may be integrated on separate semiconductor dies in a single Multi-Chip Package (MCP) or System on Chip (SoC), and may be interconnected by an internal bus. Further alternatively, some or all of the memory controller circuitry may reside on the same die on which one or more of the memory devices are disposed.

Further alternatively, some or all of the functionality of memory controller 40, e.g., part or all of the functionality of aggregation logic 48, can be implemented in hardware and/or software and carried out by a processor or other element of the host system, or by any other type of memory controller. In some embodiments, host 28 and storage device 24 may be fabricated on the same die, or on separate dies in the same device package.

### Methods for Reducing the Rate of Cache Invalidations

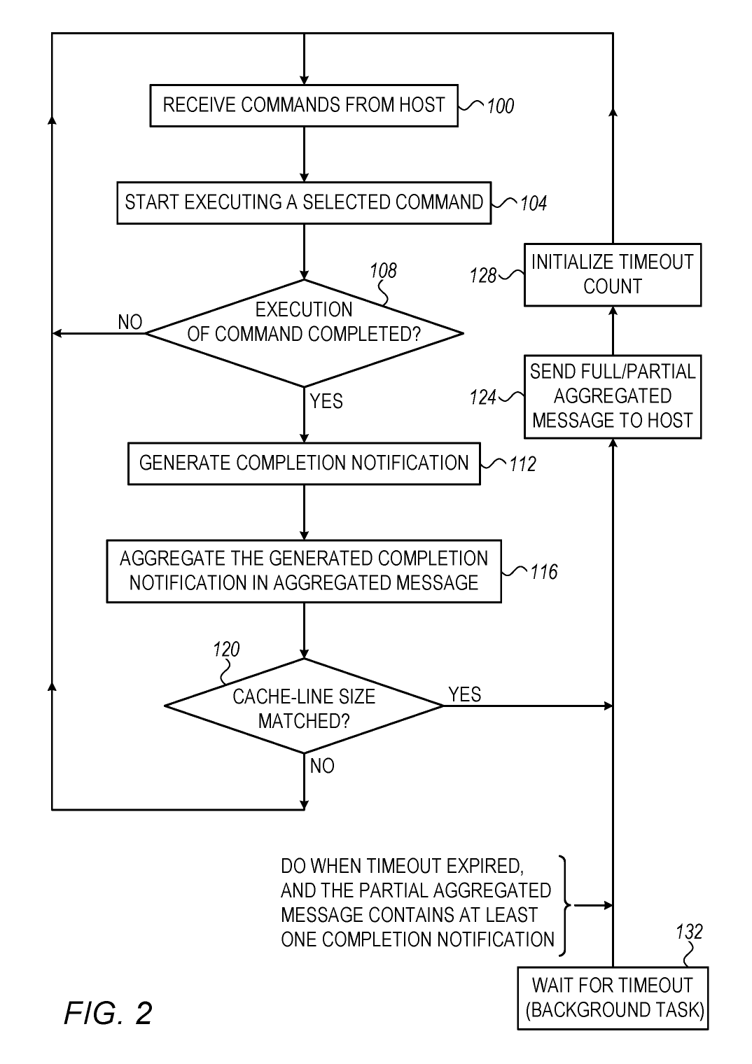

FIG. 2 is a flow chart that schematically illustrates a method for aggregating messages for reducing cache invalidation rate, in accordance with an embodiment that is described herein. The method will be described as being executed by memory controller 40 of storage device 24 in storage system 20.

In describing the method we assume a cache-line size of 64 Bytes, and a completion notification message size of 16 Bytes. Using these sizes, the controller aggregates four completion notification messages to produce a full aggregated message. In addition, the controller aggregates the completion notifications so that the completion notifications will be queued in the CQ aligned to a respective cache line of the cache memory, and cause a single cache invalidation notification for this cache line, as described above.

The method described below takes into consideration situations in which the host may not have any commands to send to the memory device for a long period of time. In such cases, the memory controller 40 may receive less than the number of commands needed to produce a full aggregated message of completion notifications. Consequently, one or more pending completion notifications may not be sent to the host until additional commands are received and executed.

In some embodiments, to break such a deadlock condition, the controller supports sending aggregated messages that match the cache-line size, also referred to herein as “full aggregated messages,” as well as aggregated messages that contain less than required for matching the cache-line size, also referred to herein as “partial aggregated messages.” Conditions for sending full and partial aggregated messages are described below.

The method of FIG. 2 begins with controller 40 receiving one or more commands from host 28 via link 32, at a command reception step 100. For example, the commands may comprise storage operation commands, i.e., write or read operations. Note that at step 100, the controller receives a command from the host if such a command has arrived at the storage device, but proceeds to step 104 if no commands have arrived.

At a command selection step 104, the controller selects one of the commands received at step 100 that was not yet executed, and starts executing the selected command. When multiple commands are pending for execution, the controller may select a command using any suitable selection criterion, such as, for example, according to predefined command priorities.

At a completion check step 108, the controller checks whether the command whose execution started at step 104 has completed, and if not, loops back to step 100 to receive subsequent commands. Otherwise, at step 108 the command execution has completed, and the controller proceeds to a completion step 112, to generate for the completed command a respective completion notification message. The completion notification message may comprise, for example, a status field indicating whether or not the command completed successfully, and an identifier of the command.

At an aggregation step 116, the controller aggregates the completion notification generated at step 112 to previously aggregated completion notifications for producing an aggregated message. In case the completion notification generated is the first one after sending an aggregated message to the host, the controller initializes a fresh aggregated message with the completion notification.

The controller may implement the aggregation of completion notifications in any suitable way. In an example embodiment, the controller holds for the aggregated message a variable denoted AGR_MSG having the same size as the cache-line size, and sets this variable to zero after sending a full or partial aggregated message to the host. In aggregating the completion notifications, the controller may apply a logical OR operation between ARG_MSG and a suitably shifted version of each completion notification message.

Table 1 below depicts the number of completion notifications in the current cache line, and the number of completion notifications yet to be aggregated to fill the cache line.

TABLE 1
notifications in cache line vs. yet to be
aggregated notifications to fill the cache line

| Number of notifications | Number of notifications yet |
|---|---|
| written to the current cache | to aggregate to fill the |
| line | current cache line |
| 0 | 4 |
| 1 | 3 |
| 2 | 2 |
| 3 | 1 |

Table 1 takes into consideration the (up to three) notifications written after a recent timeout event (as will be described below). Also, full aggregated messages are messages that complete a cache line. The current cache line is the cache-aligned (64-Bytes) address of the completion queue (e.g., as in NVMe). Aggregation cases are now described.
1. Writing completion to a 64-Byte aligned address will result in aggregating four completion messages to fill a cache line:

TABLE 2
Writing completion messages to aligned address

| Completion | | | | |
|---|---|---|---|---|
| message | CMPL_1 | CMPL_2 | CMPL_3 | CMPL_4 |
| Cache line | 0x0 | 0x10 | 0x20 | 0x30 |
| Address | | | | |

2. Writing completion to a 64-Byte address with offset 0x10 will result in aggregating three completion messages to fill a cache line:
3.

TABLE 3
Writing completion messages to address with offset 0x10

| Completion | | | | |
|---|---|---|---|---|
| message | | CMPL_1 | CMPL_2 | CMPL_3 |
| Cache line | 0x0 | 0x10 | 0x20 | 0x30 |
| Address | | | | |

4. Writing completion to a 64-Byte address with offset 0x20 will result in aggregating two completion messages to fill a cache line:

TABLE 4
Writing completion messages to address with offset 0x20

| Completion | | | | |
|---|---|---|---|---|
| message | | | CMPL_1 | CMPL_2 |
| Cache line | 0x0 | 0x10 | 0x20 | 0x30 |
| Address | | | | |

5. Writing completion to a 64-Byte address with offset 0x30 does not require aggregation to fill a cache line:

TABLE 5
Writing completion message to address with offset 0x30

| Completion | | | | |
|---|---|---|---|---|
| message | | | | CMPL_1 |
| Cache line | 0x0 | 0x10 | 0x20 | 0x30 |
| Address | | | | |

At a matching verification step 120, the controller checks whether a full aggregated message is ready for sending, by checking whether the currently-aggregated completion notifications match the cache-line size.

In the present example, a matching occurs when four completion notifications have been aggregated. In other embodiments, the cache-line size is not an integer multiple of the completion notification size, and the controller detects a matching when a maximal number of completion notifications is aggregated without exceeding the cache-line size. For example, a matching will be detected when three 16-Byte notifications are aggregated for a 60-Byte cache-line size.

If at step 120 the controller detects a match the controller sends the full aggregated message to the host, at a sending step 124. In addition, the controller re-initializes a timeout count at a timeout initialization step 128, and loops back to step 100 to receive subsequent commands.

If at step 120 the matching verification fails, the number of currently aggregated completion notifications is less than required to produce a full aggregated message that spans up to a cache line aligned address, and the controller loops back to step 100 to receive subsequent commands.

At a waiting step 132, the controller checks whether the timeout count initialized at step 128 has expired, e.g., by cyclically polling the value of the timeout count or using an interrupt signal. If at step 132 the timeout expires, and the partial aggregated message is not empty, i.e., the partial aggregated message contains at least one pending completion notification, the controller proceeds to step 124, to send any pending completion notifications within the partially aggregated message to the host, and to re-initialize the timeout count at step 128.

Aggregating the completion notifications causes inherent delays in reporting the completion notifications. In some embodiments, to avoid unnecessary delays, the controller enables the aggregation operation conditionally, based on the number of commands pending for execution or whose execution has not yet completed. When this number of commands is less than or equal to a predefined threshold number, the controller sends individual completion notifications to the host without aggregation to avoid unnecessary reporting delays. Otherwise, the number of pending commands exceeds the threshold number, and the controller enables the aggregation feature and aggregates the completion notifications as described above. In some embodiments, the controller configures the threshold number to the number of messages matching the cache-line size.

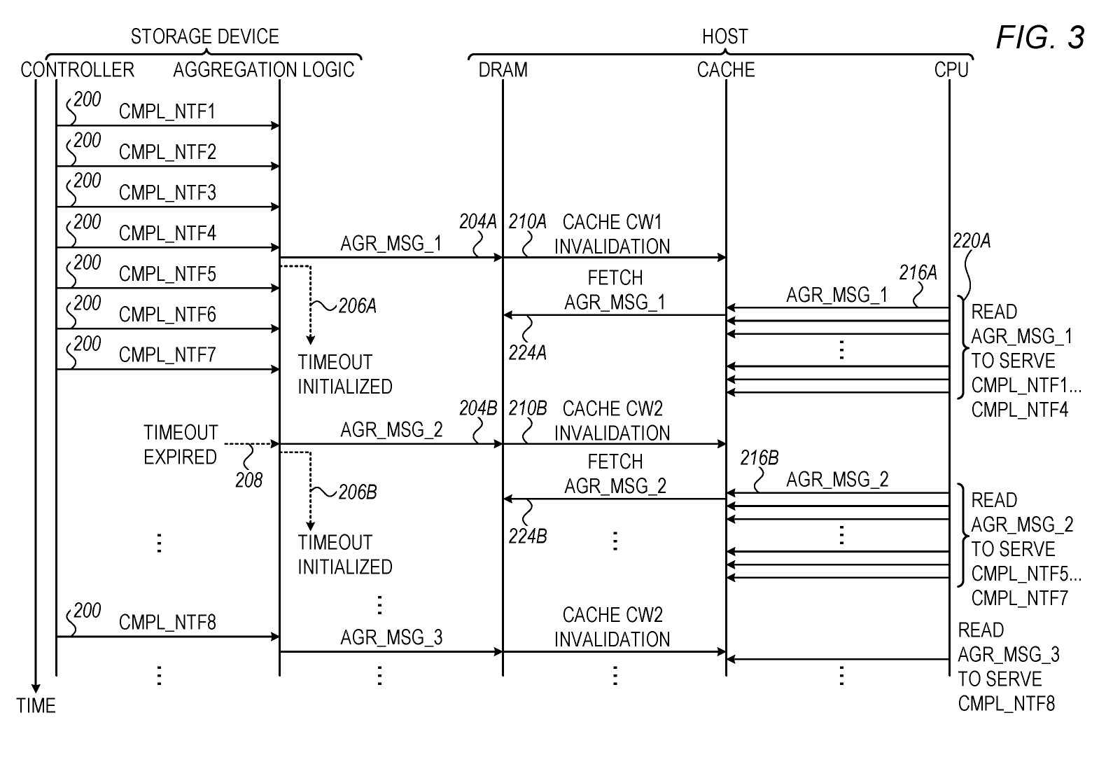

FIG. 3 is a message diagram that schematically illustrates a process of handling aggregated completion notifications in storage system 20, in accordance with an embodiment that is described herein. The vertical lines in FIG. 3 correspond to various functional elements involved in the flow, i.e., controller 40 and aggregation logic 48 of storage device 24, and DRAM 54, cache memory 58 and CPU 50 of host 28.

In the present example, the controller generates a sequence of eight completion notifications denoted CMPL_NTF1 . . . CMPL_NTF8. Arrows 200 indicate reporting the completion notifications to the aggregation logic. In this example, the first seven completion notifications arrive in a burst (i.e., relatively close to one another in time), whereas completion notification CMPL_NTF8 is generated after a long delay relative to CMPL_NTF7. The completion notifications are generated by the controller in response to receiving storage and/or control commands from the host (not shown).

The aggregation logic aggregates the first four completion notifications CMPL_NTF1 . . . CMPL_4 to produce a full aggregated message denoted AGR_MSG_1, e.g., as described above, and the full aggregated message is sent to the host as depicted by arrow 204A. In this example, upon sending AGR_MSG_1, the controller initializes the timeout count (arrow 206A).

At the host, the four completion notifications CMPL_NTF1 . . . CMPL_NTF4 are queued in a group of four consecutive CQ elements of the CQ in the DRAM, aligned to a cache line denoted CW1 of the cache memory. Updating the CQ elements corresponding to CW1 invalidates CW1 as depicted by arrow 210A.

In some embodiments, the CPU polls the DRAM via the cache controller for detecting unserved completion notifications. In other embodiments, the CPU is triggered by an interrupt signal indicating the unserved completion notifications.

In the present example, to serve each of completion notification CMPL_NTF1 . . . CMPL_NTF4, the CPU reads AGR_MSG_1 one or more times by reading CW1 in the cache (220A). Since CW1 was invalidated, however, upon the first reading of AGR_MSG_1 (arrow 216A) the cache controller fetches AGR_MSG_1 from the DRAM into CW1 of the cache memory in a single fetching transaction as depicted by arrow 224A. The CPU can then efficiently read AGR_MSG_1 multiple times, directly from the cache, for serving each of completion notifications CMPL_NTF1 . . . CMPL_NTF4.

Next, the aggregation logic aggregates three subsequent completion notifications CMPL_NTF5 . . . CMPL_NTF7, e.g., as they arrive. Since the timeout expires (arrow 208) before completion notification CMPL_NTF8 is available, the three notifications CMPL_NTF5 . . . CMPL_NTF7 produce only a partial aggregated message AGR_MSG_2, which the controller sends to the host as depicted by arrow 204B. With sending the partial message, the controller re-initializes the timeout count (arrow 206B). The updating of the respective three CQ elements in the CQ in the DRAM invalidates a cache line denoted CW2 in the cache memory (arrow 210B). Reading AGR_MSG_2 from invalidated CW2 of the cache memory, results in the cache controller fetching AGR_MSG_2 from the DRAM into the cache memory in a single transaction (arrow 224B), and the CPU can then access CW2 multiple times to serve completion notifications CMPL_NTF5 . . . CMPL_NTF7, as required.

When CMPL_NTF8 becomes available, the aggregation logic writes it as the last 16 Bytes of the 64-Byte cache line to produce a full aggregated message denoted AGR_MSG_3, and sends the full aggregated message to the host, which again invalidates CW2 in the cache memory. The CPU can then serve CMPL_NTF8 by reading ARG_MSG3 (in cache line CW2) one or more times, as required.

By using the disclosed embodiments, the cache memory is invalidated only once per four completion notifications. In addition, an aggregated message containing the four notification completions is fetched into the cache only once and can be accessed efficiently by the CPU multiple times as required for serving each of the completion notifications.

The embodiments described above are given by way of example, and alternative suitable embodiments can also be used. Consider, for example, a system having multiple CPUs that have L1 cache memories of different cache line sizes and a common L2 cache, which is also used for inter-CPU communication. In an example system of this sort with CPUs denoted CPU1 and CPU2, CPU1 has a L1 cache with a cache line size of 64 Bytes, and CPU2 has a L1 cache with a cache line size of 128 Bytes. CPU1 and CPU2 share a common L2 cache and communicate with each other using the L2 cache. Since CPU1 sends messages to the L2 cache in a 64-Byte granularity and CPU2 fetches messages from the L2 cache to its L1 cache in a 128-Byte granularity, cache line trashing occurs whenever CPU1 sends a message that invalidates the associated CPU2 L1 cache line. Therefore, the CPU1 messages can be aggregated to invalidate the CPU2 L1 cache once, similarly to the embodiments described above.

It will thus be appreciated that the embodiments described above are cited by way of example, and that the following claims are not limited to what has been particularly shown and described hereinabove. Rather, the scope includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A storage device, comprising:
a nonvolatile memory; and
a controller, configured to:
store in the nonvolatile memory data for a host;
generate messages having a message size to be cached in the host in a cache memory having a cache-line size larger than the message size;
aggregate two or more of the messages, by producing an aggregated message that matches the cache-line size; and
send the aggregated message to the host.

2. The storage device according to claim 1, wherein the controller is configured to aggregate the two or more of the messages so that the aggregated message will be stored in the cache memory in a single cache entry.

3. The storage device according to claim 1, wherein the controller is configured to aggregate the two or more of the messages in accordance with an alignment that the host maintains between cache entries of the cache memory and messages queued in the host.

4. The storage device according to claim 1, wherein the cache-line size is an integer multiple of the message size, and wherein the controller is configured to aggregate a number of messages up to the integer multiple.

5. The storage device according to claim 1, wherein the controller is configured to receive from the host, over a communication link, multiple commands for execution, and to generate the messages in response to completing execution of the respective commands.

6. The storage device according to claim 1, wherein, in response to detecting that a number of currently-aggregated messages remains less than required for matching the cache-line size for more than a predefined duration, the controller is configured to send the aggregated message to the host with only the currently-aggregated messages.

7. The storage device according to claim 1, wherein the controller is configured to produce the aggregated message and send the aggregated message to the host when a number of received commands that are pending execution exceeds a predefined threshold number, and to otherwise send individual messages to the host without aggregation.

8. A method, comprising:
in a controller that stores data for a host in a nonvolatile memory, generating messages having a message size, wherein the messages are to be cached in the host in a cache memory having a cache-line size larger than the message size;
aggregating two or more of the messages, by producing an aggregated message that matches the cache-line size; and
sending the aggregated message to the host.

9. The method according to claim 8, wherein aggregating the two or more of the messages comprises aggregating the two or more of the messages so that the aggregated message will be stored in the cache memory in a single cache entry.

10. The method according to claim 8, wherein aggregating the two or more of the messages comprises aggregating the two or more of the messages in accordance with an alignment that the host maintains between cache entries of the cache memory and messages queued in the host.

11. The method according to claim 8, wherein the cache-line size is an integer multiple of the message size, and wherein aggregating the two or more of the messages comprises aggregating a number of messages up to the integer multiple.

12. The method according to claim 8, wherein generating the messages comprises receiving from the host, over a communication link, multiple commands for execution, and generating the messages in response to completing execution of the respective commands.

13. The method according to claim 8, wherein sending the aggregated message comprises, in response to detecting that a number of currently-aggregated messages remains less than required for matching the cache-line size for more than a predefined duration, sending the aggregated message to the host with only the currently-aggregated messages.

14. The method according to claim 8, and comprising producing the aggregated message and sending the aggregated message to the host when a number of received commands that are pending execution exceeds a predefined threshold number, and otherwise sending individual messages to the host without aggregation.

15. A storage system, comprising:
a host;
a storage device, configured to store data for the host in a nonvolatile memory, and to generate messages having a message size to be cached in the host in a cache memory having a cache-line size larger than the message size; and
aggregation logic, configured to aggregate two or more of the messages generated by the storage device, by producing an aggregated message that matches the cache-line size, and to send the aggregated message to the host.

16. The storage system according to claim 15, wherein the aggregation logic is comprised in the storage device.

17. The storage system according to claim 15, wherein the aggregation logic is comprised in the host.
